(19) United States
(12) Patent Application Publication
(10) Pub. No.: US 2010/0214710 A1
(43) Pub. Date: Aug. 26, 2010

(54) SEMICONDUCTOR DEVICE MEASURING VOLTAGE APPLIED TO SEMICONDUCTOR SWITCH ELEMENT

(75) Inventor: Masayuki KORA, Chiyoda-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku (JP)

(21) Appl. No.: 12/603,735

(22) Filed: Oct. 22, 2009

(30) Foreign Application Priority Data
Feb. 23, 2009 (JP) 2009-039659

(51) Int. Cl. H02H 9/02; H02H 9/04

(52) U.S. Cl. 361/101

(57) ABSTRACT

A semiconductor device includes a semiconductor switch element having a first conductive electrode and a second conductive electrode, and a voltage measurement circuit for measuring voltage between the first conductive electrode and the second conductive electrode of the semiconductor switch element. The voltage measurement circuit includes a constant voltage element connected in parallel with the semiconductor switch element for limiting voltage applied in a conducting direction of the semiconductor switch element to a prescribed value, a control switch connected in parallel with the constant voltage element, and a switch control unit turning on the control switch when the semiconductor switch element is off, and turning off the control switch when the semiconductor switch element is on.

### BACKGROUND OF THE INVENTION

1. Field of the Invention

The present invention relates to a semiconductor device, and in particular, to a semiconductor device measuring voltage applied to a semiconductor switch element.

2. Description of the Background Art

In a semiconductor switching device, such as an inverter, used for controlling rotation speed of a motor, used in an alternating current (AC) power supply device, and the like, for example, a method of measuring on-voltage when current flows through a semiconductor switch element is employed to detect that the semiconductor switch element is in an overcurrent state.

Overcurrent protection in an IPM (Intelligent Power Module) with a built-in drive circuit used in an inverter or the like is performed, for example, as described below. Specifically, a current sensor is provided to an IGBT (Insulated Gate Bipolar Transistor) chip, and the current sensor and a resistor are connected to monitor voltage across the resistor. If voltage exceeding a prescribed value is generated, it is recognized that overcurrent is generated in the IGBT chip, and thus a gate signal to the IGBT chip is cut off and an error signal is output.

As a configuration provided with a semiconductor switch element and performing measurement of voltage applied to the semiconductor switch element and the like, for example, Japanese Patent Laying-Open No. 05-030727 (Patent Document 1) discloses a transformer as described below. Specifically, a first resistor and a Zener diode are connected in series between an anode and a cathode of an optically triggered thyristor, and a series connected body of a second resistor and an LED is connected in parallel with the Zener diode.

Japanese Patent Laying-Open No. 59-163919 (Patent Document 2) discloses a configuration as described below. Specifically, an on-voltage detector detecting on-voltage of a power transistor includes a high resistance resistor not causing a large power loss, a clamping Zener diode for not supplying an excessive voltage input to a comparator, and a diode connected in series with the Zener diode. Japanese Patent Laying-Open No. 61-121115 (Patent Document 3) discloses a configuration as described below. Specifically, the configuration includes a first resistor connected to a connection portion between one end of a solenoid and a collector of a drive element, a second resistor connected in series with the first resistor, a capacitor connected in parallel with the second resistor, and a Zener diode connected in parallel with the second resistor.

Japanese Patent Laying-Open No. 2006-136086 (Patent Document 4) discloses a configuration as described below. Specifically, a series circuit of a first resistor and a second resistor is connected between a source and a drain of an MOSFET whose current is to be detected. On-voltage of the MOSFET is divided by a voltage dividing circuit including the first resistor and the second resistor, captured by a sense circuit, and converted into current, and thus the current flowing through the MOSFET is sensed. In this configuration, a voltage dividing ratio of the voltage dividing circuit including the first resistor and the second resistor varies depending on temperature, and the voltage dividing ratio is increased with an increase in temperature.

Japanese Patent Laying-Open No. 05-184133 (Patent Document 5) discloses a configuration as described below. Specifically, a capacitor and a resistor are connected in series between an anode and a cathode of each optical thyristor, and a connection point thereof is connected to a base of a transistor via a diode and a first Zener diode. A collector and an emitter of the transistor are connected in parallel with a second Zener diode.

In order to provide a current sensor to an IGBT chip as described above, chip design requires an advanced technique, such as setting a constant ratio between a main current and a sense current. If the ratio between a main current and a sense current varies widely, there may occur a malfunction that a gate signal is cut off although current not recognized as overcurrent is generated, a malfunction that a gate signal is not cut off although overcurrent is generated, and the like.

Another conceivable configuration is that a collector potential of an IGBT is monitored through a diode having a high breakdown voltage, and protection operation is performed in a drive circuit. However, such a configuration requires a diode having breakdown voltage more than or equal to power supply voltage, and also requires an expensive IC (Integrated Circuit) for monitoring and the like. Further, since voltage between a collector and an emitter of the IGBT varies widely, malfunctions as described above are likely to occur.

However, Patent Documents 1 to 5 do not disclose a configuration for solving problems as described above.

### SUMMARY OF THE INVENTION

The present invention has been made to solve the aforementioned problems, and one object of the present invention is to provide a semiconductor device capable of accurately measuring voltage applied to a semiconductor switch element with a simple configuration.

A semiconductor device in accordance with an aspect of the present invention includes a semiconductor switch element having a first conductive electrode and a second conductive electrode, and a voltage measurement circuit for measuring voltage between the first conductive electrode and the second conductive electrode of the semiconductor switch element. The voltage measurement circuit includes a constant voltage element connected in parallel with the semiconductor switch element for limiting voltage applied in a conducting direction of the semiconductor switch element to a prescribed value, a control switch connected in parallel with the constant voltage element, and a switch control unit turning on the control switch when the semiconductor switch element is off, and turning off the control switch when the semiconductor switch element is on.

According to the present invention, voltage applied to a semiconductor switch element can be measured accurately with a simple configuration.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a semiconductor device in accordance with a first embodiment of the present invention.

FIG. 2 is a timing chart showing an operation that the semiconductor device in accordance with the first embodiment of the present invention detects on-voltage of a semiconductor switch element 10.

FIG. 3 shows a configuration of a semiconductor device in accordance with a second embodiment of the present invention.

FIG. 4 shows a configuration of a semiconductor device in accordance with a third embodiment of the present invention.

FIG. 5 shows a configuration of a semiconductor device in accordance with a fourth embodiment of the present invention.

FIG. 6 is a timing chart showing an operation that a semiconductor device in accordance with a fifth embodiment of the present invention detects on-voltage of semiconductor switch element 10.

FIG. 7 shows a configuration of a semiconductor device in accordance with a sixth embodiment of the present invention.

FIG. 8 shows a configuration of a semiconductor device in accordance with a seventh embodiment of the present invention.

FIG. 9 shows a configuration of a semiconductor device in accordance with an eighth embodiment of the present invention.

### DESCRIPTION OF THE PREFERRED EMBODIMENTS

Hereinafter, embodiments of the present invention will be described with reference to the drawings. It is to be noted that identical or corresponding parts in the drawings will be designated by the same reference numerals, and the description thereof will not be repeated.

### First Embodiment

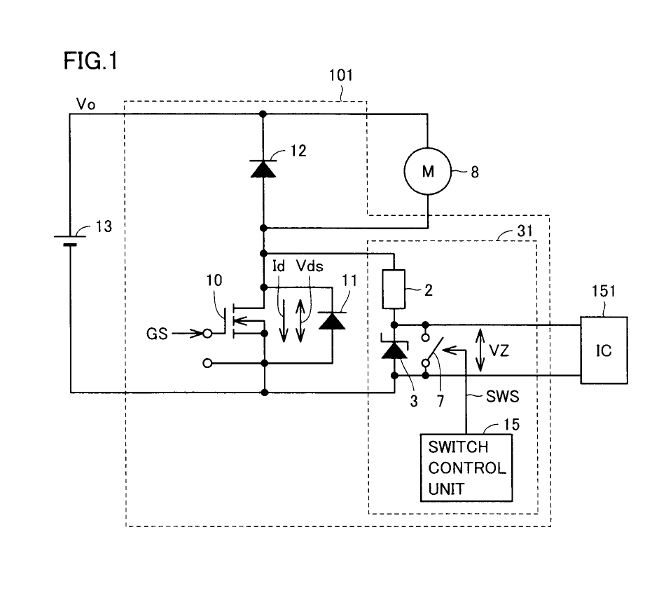

FIG. 1 shows a configuration of a semiconductor device in accordance with a first embodiment of the present invention.

Referring to FIG. 1, a semiconductor device 101 includes a semiconductor switch element 10, a diode element 11, a clamp diode 12, and a voltage measurement circuit 31. Voltage measurement circuit 31 includes a resistor 2, a Zener diode 3, a control switch 7, and a switch control unit 15.

Semiconductor device 101 drives a motor 8 based on direct current (DC) power supplied from a power supply 13. Voltage measurement circuit 31 measures voltage between a drain and a source of semiconductor switch element 10 by measuring voltage VZ applied across Zener diode 3. An IC 151 detects an overcurrent state of semiconductor switch element 10 based on a measurement result of voltage measurement circuit 31.

Semiconductor switch element 10 is, for example, an MOSFET (Metal Oxide Semiconductor Field Effect Transistor) chip. Diode element 11 has a conducting direction opposite to that of semiconductor switch element 10. Diode element 11 is, for example, a parasitic diode existing between the drain and the source of semiconductor switch element 10. Diode element 11 is used as a free wheel diode.

Semiconductor switch element 10 has a drain connected to an anode of clamp diode 12 and a first end of resistor 2, a source connected to a negative terminal of power supply 13, an anode of Zener diode 3, and a second end of control switch 7, and a gate receiving a drive signal GS. Clamp diode 12 has a cathode connected to a positive terminal of power supply 13 and a first end of motor 8, and the anode connected to a second end of motor 8.

Semiconductor switch element 10 and a series circuit of resistor 2 and Zener diode 3 are connected in parallel with each other. Control switch 7 is connected in parallel with Zener diode 3 and semiconductor switch element 10. Zener diode 3 is connected to have a conducting direction opposite to that of semiconductor switch element 10. Zener diode 3 has a cathode connected to a second end of resistor 2 and a first end of control switch 7, and the anode connected to the second end of control switch 7. IC 151 is connected to the first end and the second end of control switch 7.

Resistor 2 is provided to limit current flowing through Zener diode 3. The resistance value of resistor 2 is set to a value that allows a sufficient voltage to be applied to Zener diode 3.

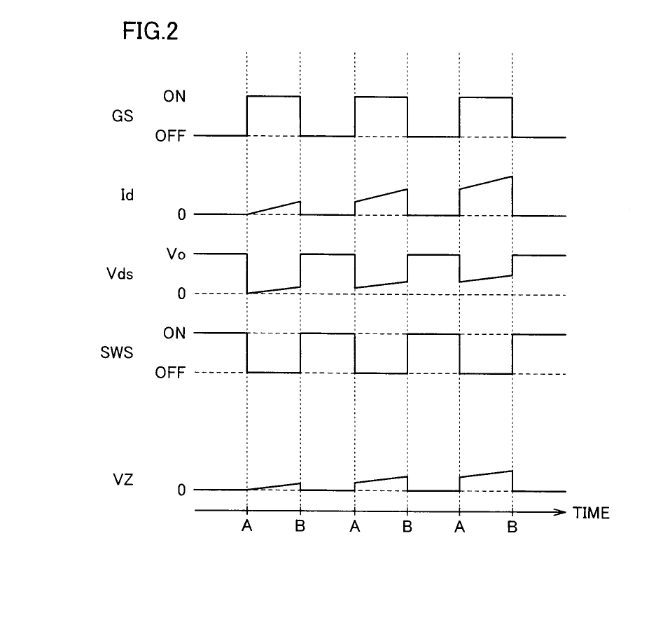

FIG. 2 is a timing chart showing an operation that the semiconductor device in accordance with the first embodiment of the present invention detects on-voltage of semiconductor switch element 10.

Referring to FIG. 2, GS represents the drive signal to semiconductor switch element 10, that is, gate voltage of semiconductor switch element 10, Id represents drain current of semiconductor switch element 10, Vds represents the voltage between the drain and the source of semiconductor switch element 10, SWS represents a control signal to control switch 7, and VZ represents the voltage across Zener diode 3.

Drive signal GS is at a logical high level in a period from timing A to timing B, and semiconductor switch element 10 is in an ON state during this period. Further, drive signal GS is at a logical low level in a period from timing B to timing A, and semiconductor switch element 10 is in an OFF state during this period.

Control signal SWS has a logical level opposite to that of drive signal GS. Specifically, control signal SWS is at a logical low level in the period from timing A to timing B, and at a logical high level in the period from timing B to timing A.

Herein, it is assumed that semiconductor device 101 does not include control switch 7 and Zener diode 3. In such a configuration, when semiconductor switch element 10 is off, output voltage V0 of power supply 13 is applied across the drain and the source of semiconductor switch element 10. Accordingly, most of output voltage Vo is also applied to voltage measurement circuit 31 connected in parallel with semiconductor switch element 10. Therefore, IC 151 having breakdown voltage more than or equal to output voltage V0 is required.

However, semiconductor device 101 includes control switch 7, and switch control unit 15 turns on control switch 7 when semiconductor switch element 10 is off. Since this can reduce the voltage applied to voltage measurement circuit 31 to 0 V, IC 151 having breakdown voltage more than or equal to output voltage V0 is not required. This can also prevent a situation where a high voltage is detected in IC 151 when semiconductor switch element 10 is off, and semiconductor switch element 10 is erroneously determined as being in an overcurrent state. Further, there is no need for IC 151 to perform control not to determine that semiconductor switch element 10 is in an overcurrent state when semiconductor switch element 10 is off, and thus control can be simplified.

In addition, switch control unit 15 turns off control switch 7 when semiconductor switch element 10 is on. For example, switch control unit 15 turns off switch 7 simultaneously when semiconductor switch element 10 is changed from an OFF state to an ON state. Thereby, voltage corresponding to the on-voltage of semiconductor switch element 10 is applied across Zener diode 3.

By the switch control as described above, voltage VZ having a voltage waveform that varies in a manner similar to that of drain current Id as shown in FIG. 2 is applied across Zener diode 3, and can be measured. Specifically, voltage VZ can be detected as the on-voltage of semiconductor switch element 10. By detecting the on-voltage of semiconductor switch element 10, current flowing through semiconductor switch element 10 can be detected, and the overcurrent state of semiconductor switch element 10 can be detected.

It is also assumed that semiconductor device 101 does not include Zener diode 3. In such a configuration, for example, if motor 8 has a failure and a short circuit occurs, since switch 7 is turned off when semiconductor switch element 10 is on, output voltage Vo is applied across semiconductor switch element 10 and across switch 7, and they may be broken down.

However, since semiconductor device 101 is configured to include Zener diode 3, the voltage applied across semiconductor switch element 10 and across switch 7 is less than or equal to Zener voltage of Zener diode 3 even when motor 8 has a failure and a short circuit occurs. Thereby, breakdown of semiconductor switch element 10 and switch 7 can be prevented.

Further, since voltage VZ does not exceed the Zener voltage of Zener diode 3 in semiconductor device 101, IC 151 for measuring voltage VZ does not have to have a high breakdown voltage. Therefore, IC 151 can be easily designed, and size and cost can be reduced.

In addition, since breakdown voltage of switch 7 just has to be slightly greater than the Zener voltage of Zener diode 3, and current flowing through switch 7 is limited by resistor 2, a switch with a small capacity can be used. Therefore, size and cost can be reduced.

As has been described above, in the semiconductor device in accordance with the first embodiment of the present invention, the voltage applied to the semiconductor switch element can be measured accurately with a simple configuration. Thereby, the overcurrent state of semiconductor switch element 10 can be detected precisely, and thus yield can be improved.

It is to be noted that, although it has been described that semiconductor switch element 10 is, for example, an MOSFET chip in the semiconductor device in accordance with the first embodiment of the present invention, semiconductor switch element 10 is not limited thereto, and may be another semiconductor switch element such as an IGBT.

Further, although it has been described that the semiconductor device in accordance with the first embodiment of the present invention is configured to include Zener diode 3, the semiconductor device may include, other than Zener diode 3, any constant voltage element connected in parallel with semiconductor switch element 10 to limit voltage applied in the conducting direction of semiconductor switch element 10 to a prescribed value. Examples of such a constant voltage element include a varistor.

Furthermore, although it has been described that the semiconductor device in accordance with the first embodiment of the present invention is configured to use the parasitic diode of semiconductor switch element 10 as a free wheel diode, the configuration of the semiconductor device is not limited thereto. It may be configured to be additionally provided with an SBD (Schottky barrier diode) having a small forward voltage or the like as a free wheel diode, to suppress power consumption during regeneration of motor 8 even when an IGBT without having a parasitic diode is used as semiconductor switch element 10, or even when an MOSFET is used as semiconductor switch element 10.

Next, another embodiment of the present invention will be described with reference to a drawing. It is to be noted that identical or corresponding parts in the drawing will be designated by the same reference numerals, and the description thereof will not be repeated.

### Second Embodiment

The present embodiment relates to a semiconductor device in which a constant voltage element is changed when compared with the semiconductor device in accordance with the first embodiment. Other than that described below, the semiconductor device in accordance with the present embodiment is the same as the semiconductor device in accordance with the first embodiment.

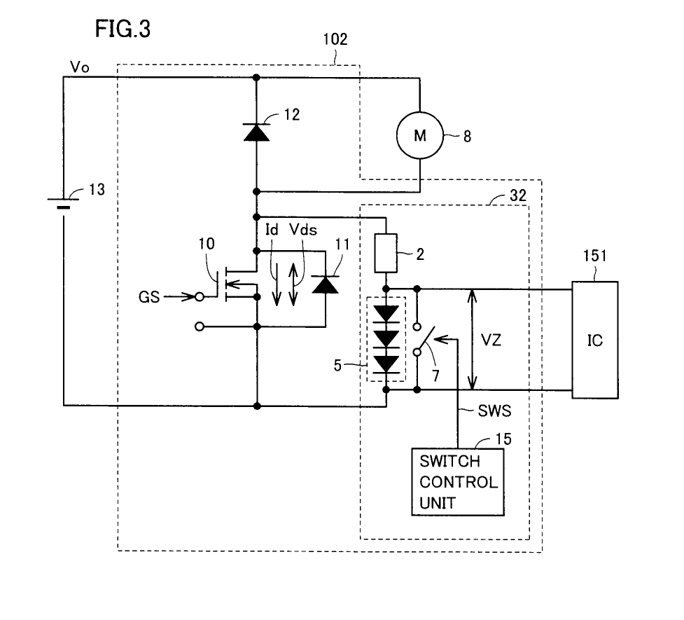

FIG. 3 shows a configuration of a semiconductor device in accordance with a second embodiment of the present invention.

Referring to FIG. 3, a semiconductor device 102 includes a voltage measurement circuit 32 instead of voltage measurement circuit 31 when compared with the semiconductor device in accordance with the first embodiment of the present invention. Voltage measurement circuit 32 includes resistor 2, a diode unit 5, control switch 7, and switch control unit 15.

Diode unit 5 is connected in series with resistor 2. Semiconductor switch element 10 and a series circuit of resistor 2 and diode unit 5 are connected in parallel with each other. Control switch 7 is connected in parallel with diode unit 5 and semiconductor switch element 10. Diode unit 5 includes a plurality of diodes connected in series to have a conducting direction identical to that of semiconductor switch element 10. Diode unit 5 limits voltage applied in the conducting direction of semiconductor switch element 10 to a prescribed value.

Voltage measurement circuit 32 measures the voltage between the drain and the source of semiconductor switch element 10 by measuring voltage VZ applied across diode unit 5.

In the semiconductor device in accordance with the second embodiment of the present invention, a maximum level of voltage VZ can be adjusted by changing the number of diodes in diode unit 5.

Since other configurations and operations are the same as those of the semiconductor device in accordance with the first embodiment, the detailed description thereof will not be repeated here.

It is to be noted that, although it has been described that the semiconductor device in accordance with the second embodiment of the present invention is configured to include diode unit 5, the semiconductor device may include, other than a diode, a semiconductor element conducting in two directions such as a varistor. Also with such a configuration, an effect similar to that of the semiconductor device in accordance with the second embodiment of the present invention can be achieved.

Next, another embodiment of the present invention will be described with reference to a drawing. It is to be noted that identical or corresponding parts in the drawing will be designated by the same reference numerals, and the description thereof will not be repeated.

### Third Embodiment

The present embodiment relates to a semiconductor device additionally provided with a function of adjusting voltage VZ when compared with the semiconductor device in accordance with the first embodiment. Other than that described below, the semiconductor device in accordance with the present embodiment is the same as the semiconductor device in accordance with the first embodiment.

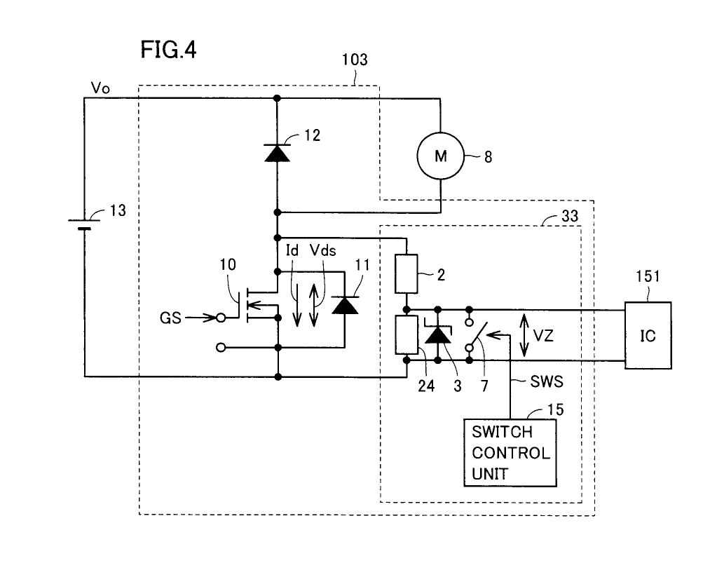

FIG. 4 shows a configuration of a semiconductor device in accordance with a third embodiment of the present invention.

Referring to FIG. 4, a semiconductor device 103 includes a voltage measurement circuit 33 instead of voltage measurement circuit 31 when compared with the semiconductor device in accordance with the first embodiment of the present invention. Voltage measurement circuit 33 includes resistor 2, Zener diode 3, control switch 7, switch control unit 15, and a resistor 24. Resistor 24 is connected in series with resistor 2, and connected in parallel with semiconductor switch element 10, diode element 11, Zener diode 3, and control switch 7.

In semiconductor device 101, the voltage between the drain and the source of semiconductor switch element 10 in an ON state, that is, the on-voltage, is applied across Zener diode 3.

On the other hand, in semiconductor device 103, the on-voltage of semiconductor switch element 10 can be divided by resistor 2 and resistor 24, and thus the maximum level of voltage VZ applied across Zener diode 3 can be adjusted.

The level of voltage VZ can also be adjusted by replacing resistor 2 with a plurality of resistors connected in series, or by adjusting the resistance value of resistor 2.

Since other configurations and operations are the same as those of the semiconductor device in accordance with the first embodiment, the detailed description thereof will not be repeated here.

Next, another embodiment of the present invention will be described with reference to a drawing. It is to be noted that identical or corresponding parts in the drawing will be designated by the same reference numerals, and the description thereof will not be repeated.

### Fourth Embodiment

The present embodiment relates to a semiconductor device additionally provided with a function of stabilizing voltage VZ when compared with the semiconductor device in accordance with the first embodiment. Other than that described below, the semiconductor device in accordance with the present embodiment is the same as the semiconductor device in accordance with the first embodiment.

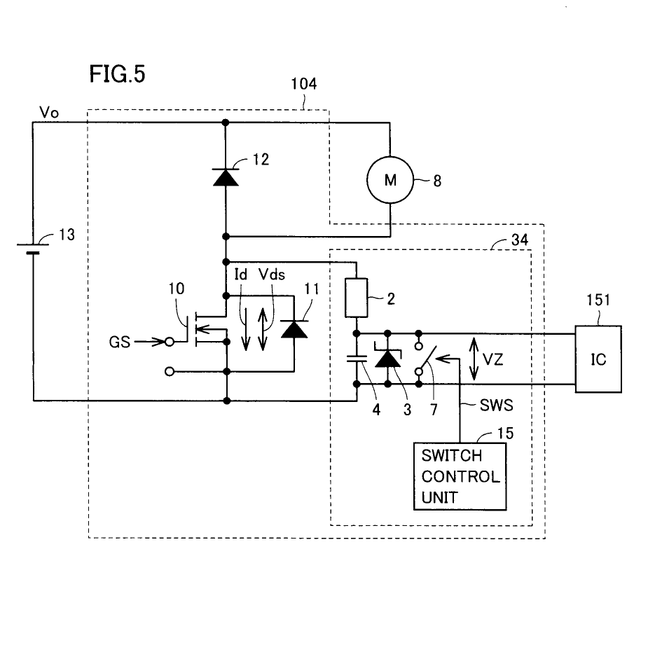

FIG. 5 shows a configuration of a semiconductor device in accordance with a fourth embodiment of the present invention.

Referring to FIG. 5, a semiconductor device 104 includes a voltage measurement circuit 34 instead of voltage measurement circuit 31 when compared with the semiconductor device in accordance with the first embodiment of the present invention. Voltage measurement circuit 34 includes resistor 2, Zener diode 3, control switch 7, switch control unit 15, and a capacitor 4. Capacitor 4 is connected in series with resistor 2, and connected in parallel with semiconductor switch element 10, diode element 11, Zener diode 3, and control switch 7.

In semiconductor device 104, a sudden change in the level of voltage VZ due to noise and ringing caused when semiconductor switch element 10 makes transition between an ON state and an OFF state can be suppressed by capacitor 4. Thereby, a malfunction regarding overcurrent detection can be prevented.

Since other configurations and operations are the same as those of the semiconductor device in accordance with the first embodiment, the detailed description thereof will not be repeated here.

Next, another embodiment of the present invention will be described with reference to a drawing. It is to be noted that identical or corresponding parts in the drawing will be designated by the same reference numerals, and the description thereof will not be repeated.

### Fifth Embodiment

The present embodiment relates to a semiconductor device in which control by switch control unit 15 is changed when compared with the semiconductor device in accordance with the first embodiment. Other than that described below, the semiconductor device in accordance with the present embodiment is the same as the semiconductor device in accordance with the first embodiment.

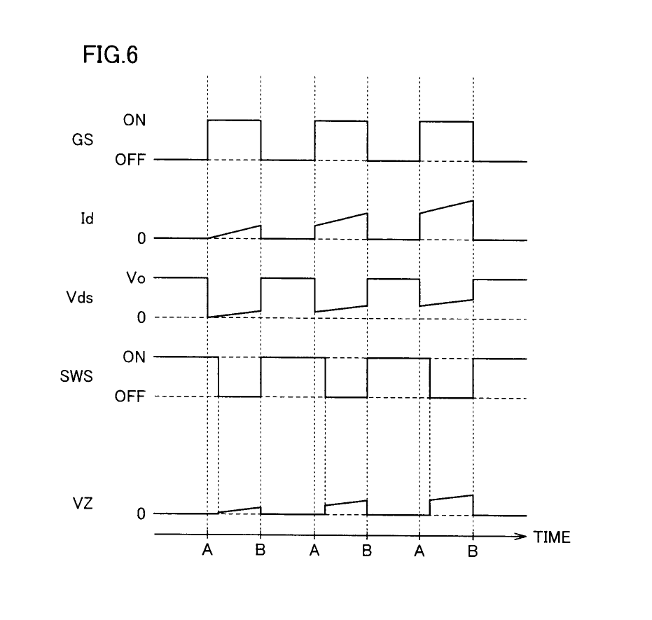

FIG. 6 is a timing chart showing an operation that a semiconductor device in accordance with a fifth embodiment of the present invention detects the on-voltage of semiconductor switch element 10.

Referring to FIG. 6, switch control unit 15 maintains control switch 7 to be in an ON state until a predetermined time elapses after semiconductor switch element 10 is turned on, and turns off control switch 7 after the predetermined time elapses.

Specifically, control signal SWS is at a logical high level in the period from timing B to timing A, and control switch 7 is in an ON state during this period. Control signal SWS remains at the logical high level until a predetermined time elapses after timing A, and control switch 7 is maintained in the ON state during this period. Then, control signal SWS attains a logical low level after the predetermined time elapses after timing A, and control switch 7 is in an OFF state during a period to timing B.

With such a configuration, a sudden change in the level of voltage VZ due to noise and the like caused when semiconductor switch element 10 makes transition from an OFF state to an ON state can be prevented, and a malfunction regarding overcurrent detection can be prevented.

Since other configurations and operations are the same as those of the semiconductor device in accordance with the first embodiment, the detailed description thereof will not be repeated here.

Next, another embodiment of the present invention will be described with reference to a drawing. It is to be noted that identical or corresponding parts in the drawing will be designated by the same reference numerals, and the description thereof will not be repeated.

### Sixth Embodiment

The present embodiment relates to a semiconductor device in which the semiconductor device in accordance with the first embodiment is modularized. Other than that described below, the semiconductor device in accordance with the present embodiment is the same as the semiconductor device in accordance with the first embodiment.

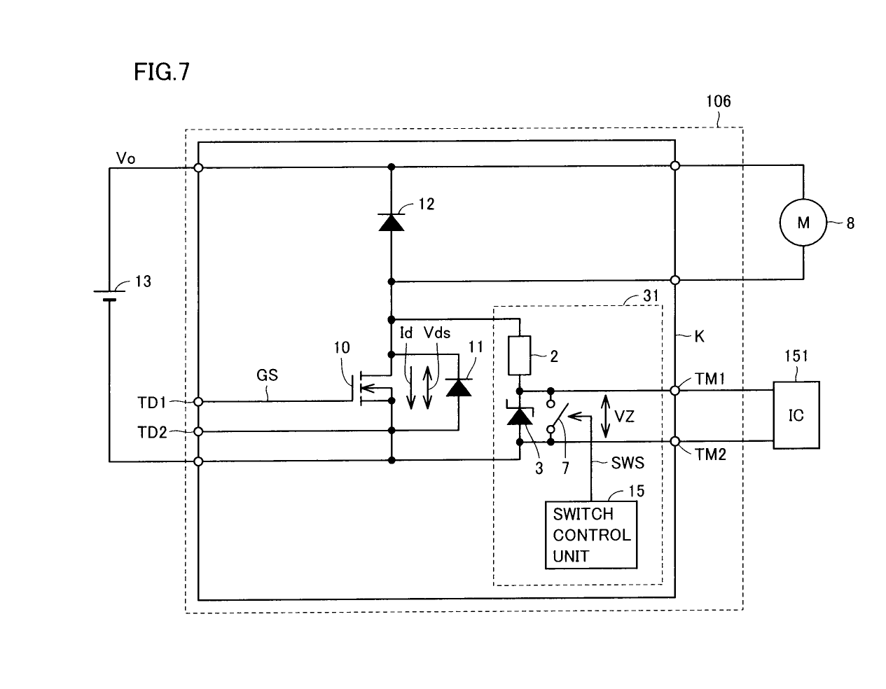

FIG. 7 shows a configuration of a semiconductor device in accordance with a sixth embodiment of the present invention.

Referring to FIG. 7, a semiconductor device 106 further includes a case K, drive terminals TD1 and TD2, and monitor terminals TM1 and TM2, when compared with the semiconductor device in accordance with the first embodiment of the present invention.

Case K accommodates semiconductor switch element 10, diode element 11, clamp diode 12, and voltage measurement circuit 31. Drive terminals TD1 and TD2 and monitor terminals TM1 and TM2 are attached to case K.

Drive signal GS is supplied from the outside of case K to the gate of semiconductor switch element 10 through drive terminal TD1. Voltage VZ applied across Zener diode 3 is supplied to IC 151 located outside case K through monitor terminals TM1 and TM2.

With such a configuration, the on-voltage of semiconductor switch element 10 can be easily measured outside semiconductor device 106.

Since other configurations and operations are the same as those of the semiconductor device in accordance with the first embodiment, the detailed description thereof will not be repeated here.

Next, another embodiment of the present invention will be described with reference to a drawing. It is to be noted that identical or corresponding parts in the drawing will be designated by the same reference numerals, and the description thereof will not be repeated.

### Seventh Embodiment

The present embodiment relates to a semiconductor device in which the semiconductor device in accordance with the first embodiment is implemented as an IPM. Other than that described below, the semiconductor device in accordance with the present embodiment is the same as the semiconductor device in accordance with the first embodiment.

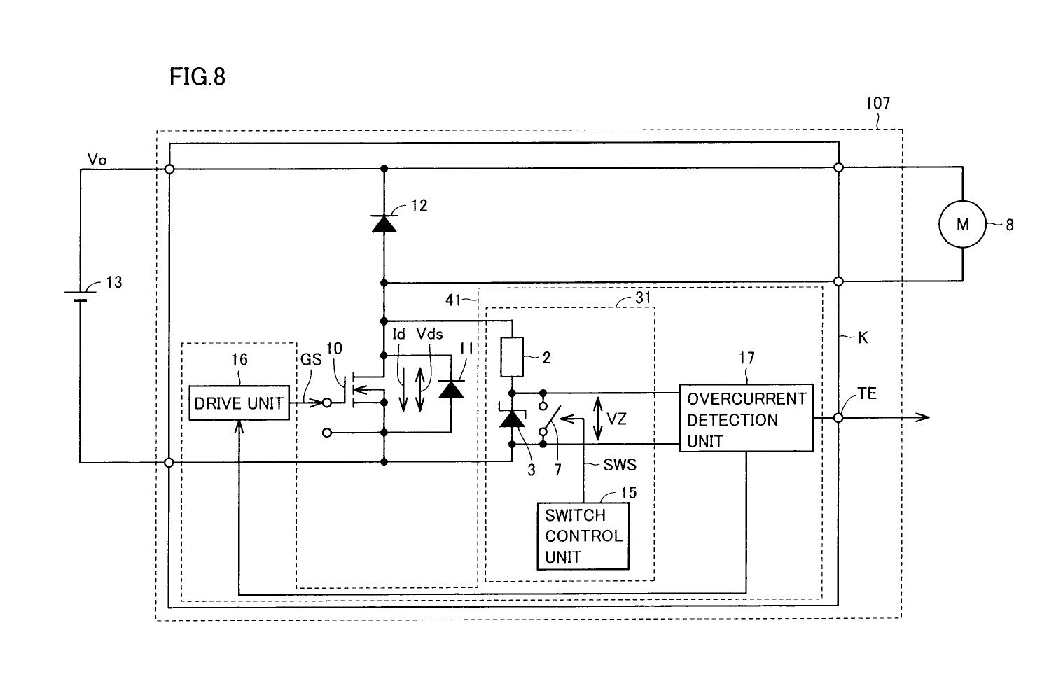

FIG. 8 shows a configuration of a semiconductor device in accordance with a seventh embodiment of the present invention.

Referring to FIG. 8, a semiconductor device 107 further includes case K, an error terminal TE, a drive unit 16, and an overcurrent detection unit 17, when compared with the semiconductor device in accordance with the first embodiment of the present invention.

Case K accommodates semiconductor switch element 10, diode element 11, clamp diode 12, voltage measurement circuit 31, drive unit 16, and overcurrent detection unit 17. Error terminal TE is attached to case K.

Drive unit 16 outputs drive signal GS for driving semiconductor switch element 10 to the gate of semiconductor switch element 10.

Overcurrent detection unit 17 performs control to stop an output of drive signal GS to semiconductor switch element 10 by drive unit 16 to turn off semiconductor switch element 10, based on the measurement result of voltage measurement circuit 31, that is, a magnitude of voltage VZ applied across Zener diode 3. Overcurrent detection unit 17 also outputs an error signal indicating that semiconductor switch element 10 is in an overcurrent state to the outside of case K through terminal TE, based on the measurement result of voltage measurement circuit 31.

As described above, since semiconductor device 107 includes drive unit 16 as well as overcurrent detection unit 17 having a function of cutting off drive signal GS inside a module, a response speed to overcurrent can be increased, and thus breakdown of semiconductor switch element 10 can be obviated. Further, since the length of a line for transmitting voltage VZ can be shortened, voltage VZ transmitted to overcurrent detection unit 17 is less likely to be affected by noise and the like, and thus a malfunction regarding overcurrent detection can be prevented.

In addition, in semiconductor device 107, voltage measurement circuit 31, drive unit 16, and overcurrent detection unit 17 are included, for example, in one integrated circuit 41, that is, one semiconductor chip. Thereby, reduction in size and cost of an entire module, and improved assembly work can be achieved.

Since other configurations and operations are the same as those of the semiconductor device in accordance with the first embodiment, the detailed description thereof will not be repeated here.

Next, another embodiment of the present invention will be described with reference to a drawing. It is to be noted that identical or corresponding parts in the drawing will be designated by the same reference numerals, and the description thereof will not be repeated.

### Eighth Embodiment

The present embodiment relates to a semiconductor device in which the type of the semiconductor switch element is changed when compared with the semiconductor device in accordance with the first embodiment. Other than that described below, the semiconductor device in accordance with the present embodiment is the same as the semiconductor device in accordance with the first embodiment.

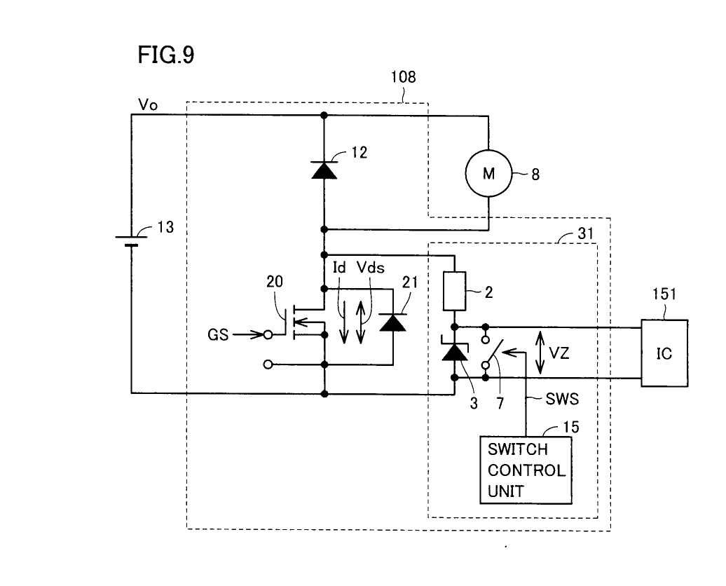

FIG. 9 shows a configuration of a semiconductor device in accordance with an eighth embodiment of the present invention.

Referring to FIG. 9, a semiconductor device 108 includes a semiconductor switch element 20 and a diode element 21 instead of semiconductor switch element 10 and a diode element 11 when compared with the semiconductor device in accordance with the first embodiment of the present invention.

Semiconductor switch element 20 and diode element 21 are formed of silicon carbide (SiC).

Since silicon carbide has a high voltage endurance, an allowable current density can be increased, and thus the sizes of the semiconductor switch element and the diode element can be reduced. Therefore, in the semiconductor device in accordance with the eighth embodiment of the present invention, further size reduction can be achieved when compared with the semiconductor device in accordance with the first embodiment of the present invention.

It is to be noted that, although it has been described that the semiconductor device in accordance with the eighth embodiment of the present invention is configured to include semiconductor switch element 20 and diode element 21 formed of silicon carbide (SiC), the configuration of the semiconductor device is not limited thereto, and the semiconductor device may be configured such that at least one of the semiconductor switch element and the diode element is formed of silicon carbide (SiC).

Since other configurations and operations are the same as those of the semiconductor device in accordance with the first embodiment, the detailed description thereof will not be repeated here.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A semiconductor device, comprising:
a semiconductor switch element having a first conductive electrode and a second conductive electrode; and
a voltage measurement circuit for measuring voltage between the first conductive electrode and the second conductive electrode of said semiconductor switch element,
said voltage measurement circuit including
a constant voltage element connected in parallel with said semiconductor switch element for limiting voltage applied in a conducting direction of said semiconductor switch element to a prescribed value,
a control switch connected in parallel with said constant voltage element, and
a switch control unit turning on said control switch when said semiconductor switch element is off, and turning off said control switch when said semiconductor switch element is on.

2. The semiconductor device according to claim 1, wherein
said constant voltage element is a Zener diode, and
said voltage measurement circuit further includes a resistor connected in series with said constant voltage element and connected in parallel with said semiconductor switch element.

3. The semiconductor device according to claim 1, wherein
said constant voltage element is a plurality of diodes connected in series, and
said voltage measurement circuit further includes a resistor connected in series with said constant voltage element and connected in parallel with said semiconductor switch element.

4. The semiconductor device according to claim 1, wherein said voltage measurement circuit further includes a resistor connected in parallel with said semiconductor switch element, said constant voltage element, and said control switch.

5. The semiconductor device according to claim 1, wherein said voltage measurement circuit further includes a capacitor connected in parallel with said semiconductor switch element, said constant voltage element, and said control switch.

6. The semiconductor device according to claim 1, wherein said switch control unit maintains said control switch to be in an ON state until a predetermined time elapses after said semiconductor switch element is turned on, and turns off said control switch after said predetermined time elapses.

7. The semiconductor device according to claim 1, further comprising:
a case accommodating said semiconductor switch element, said constant voltage element, and said control switch; and
a terminal attached to said case for measuring voltage applied to said constant voltage element.

8. The semiconductor device according to claim 1, further comprising:
a drive unit outputting a drive signal for driving said semiconductor switch element to said semiconductor switch element;
an overcurrent detection unit stopping an output of said drive signal to said semiconductor switch element by said drive unit and outputting an error signal indicating that said semiconductor switch element is in an overcurrent state, based on a magnitude of voltage applied to said constant voltage element; and
a case accommodating said semiconductor switch element, said voltage measurement circuit, said drive unit, and said overcurrent detection unit.

9. The semiconductor device according to claim 8, wherein said voltage measurement circuit, said drive unit, and said overcurrent detection unit are included in one semiconductor integrated circuit.

10. The semiconductor device according to claim 1, further comprising a diode element connected in parallel with said semiconductor switch element, said constant voltage element, and said control switch to have a conducting direction opposite to the conducting direction of said semiconductor switch element, and formed of silicon carbide.

11. The semiconductor device according to claim 10, wherein said semiconductor switch element is formed of silicon carbide.
